(19) United States
(12) Patent Application Publication
(10) Pub. No.: US 2012/0185670 A1
(43) Pub. Date: Jul. 19, 2012

(54) SCALAR INTEGER INSTRUCTIONS CAPABLE OF EXECUTION WITH THREE REGISTERS

(76) Inventors: Bret L. Toll, Hillsboro, OR (US); Robert Valentine, Kiryat Tivon (IL); Maxim Locktyukhin, Folsom, CA (US); Elmoustapha Ould-Ahmed-Vall, Chandler, AZ (US)

(21) Appl. No.: 13/007,050

(22) Filed: Jan. 14, 2011

(51) Int. Cl. G06F 15/76; G06F 9/02

(52) U.S. Cl. 712/4; 712/E09.002

(57) ABSTRACT

A processing core implemented on a semiconductor chip is described. The processing core includes logic circuitry to identify whether vector instructions and integer scalar instructions are to be executed with two registers or three registers, where, in the case of two registers input operand information is destroyed in one of two registers, and, in the case of three registers input operand is not destroyed. The processing core also includes steering circuitry coupled to the logic circuitry. The steering circuitry is to control first data paths between scalar integer execution units and a scalar integer register bank such that two registers are accessed from the scalar register bank if two register execution is identified for the scalar integer instructions or three registers are accessed from the scalar integer register bank if three register execution is identified for the scalar integer instructions. The steering circuitry is also to control second data paths between vector execution units and a vector register bank such that two registers are accessed from the vector register bank if two register execution is identified for the vector instructions or three registers are accessed from the vector register bank if three register execution is identified for the vector instructions.

### FIELD OF THE INVENTION

The field of invention relates generally to the computing sciences, and, more specifically, to scalar integer instructions that can be executed with three registers.

### BACKGROUND OF THE INVENTION

Processing cores (such as embedded cores and microprocessors) execute program code instructions to effect operation of a software program. As observed in FIG. 1, existing scalar integer program code instructions 100 include an opcode portion 101, a first register identifier 102 and a second register identifier 103. Traditionally, the opcode portion 101 specifies the operation to be performed. The first register identifier 102 identifies a first register that is used to store both: i) an scalar integer input operand for the operation, and, ii) the scalar integer result of the operation. The second scalar integer register identifier identifies a second scalar integer register that is used to store a second scalar integer input operand for the operation. Said another way, many traditional scalar integer instructions are implemented as R1=[scalar integer opcode operation] R1, R2. Besides being a second register address, R2 can also be a memory address.

Notably, the scalar integer input operand information in register R1 that exists before the result of the operation is stored in R1 is destroyed once the scalar integer result is written if precautions are not taken to store this information separately beforehand. As such, FIG. 2 shows a prior art process that has been used to save scalar integer input operand operation that would otherwise be destroyed when the result of an scalar integer instruction is stored. According to the process of FIG. 2, an scalar integer instruction 201 is executed that safely stores the scalar integer input operand information (e.g., in another register or cache or memory).

For instance, the information may be copied over (e.g., with a move (MOV) instruction) from a primary scalar integer register to a secondary scalar integer register where one of the scalar integer registers corresponds to scalar integer register R1 of the instruction. With the scalar integer input operand information stored in a pair of scalar integer registers, the destruction of the information in one of the scalar integer registers is of no consequence because the same information is preserved in the other of the scalar integer registers.

To implement the approach of FIG. 2, typically, a compiler recognizes the need to preserve the scalar integer input operand and inserts one or more additional instructions into the program code's instruction stream to separately store the scalar integer input operand before execution of the scalar integer instruction that would otherwise destroy it. The need to add the instruction(s) to separately store an scalar integer input operand prior to its use as an scalar integer input operand can be viewed as a form of inefficiency.

With respect to vector machines that execute vector instructions, a new instruction format has been introduced (advanced vector extension (AVX) technology introduced by Intel, Corp. of Santa Clara, Calif.) that appends additional information (a prefix) to the format of a vector instruction that identifies a third register that can be used as a vector instruction's source or destination register. Specifically, as observed in FIG. 3 (which shows a simplistic vector instruction format 300), AVX technology adds a prefix field 301 to an instruction 300 that includes a field of information 302 that identifies a third register (R3) for the instruction. When the vector instruction executes, for many vector AVX instructions, the use of the third register preserves the input operand information in their original registers. For example, if the vector instruction is of the form R1<=[vector opcode operation] R3, R2, the input operand information in R2 and R3 is not written over with the instruction's result (because the instruction's result is stored in R1).

Machines that are designed to support this technology can execute a number of particular vector instructions with two or three registers. For example, a particular vector instruction may be executed without the prefix information being utilized which results in one of the input operands being destroyed. The same particular vector instruction may also be executed with the prefix information being utilized so as to use three registers and not destroy any of the input operand information. Additionally, a number of vector AVX instructions do not have a 2 input operand form, but, instead, are 3 input operand instructions (e.g., (A*B)+C) with input operand destruction. That is, three input AVX instructions can take the form of, for example, R1<=[vector opcode] R3, R2, R1.

Besides vector instructions, AVX technology has also been applied to scalar floating point instructions.

### BRIEF DESCRIPTION OF THE DRAWINGS

The present invention is illustrated by way of example and not limitation in the figures of the accompanying drawings, in which like references indicate similar elements and in which:

FIG. 1 shows a traditional scalar integer instruction format;

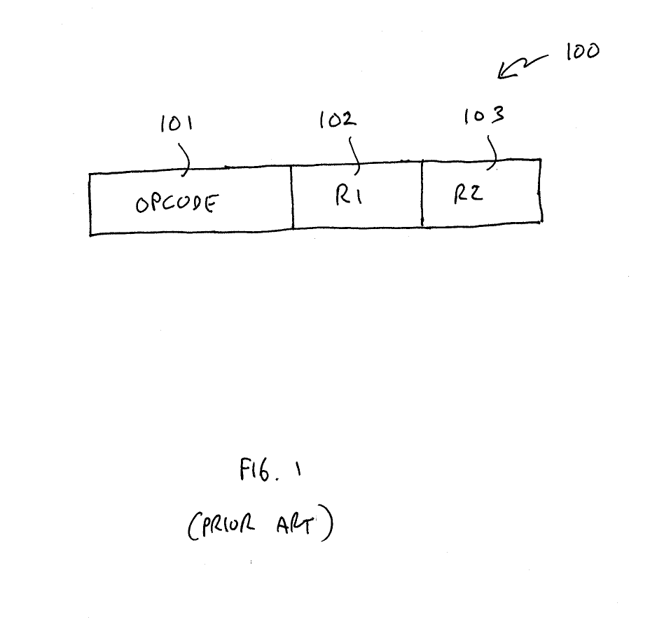

FIG. 2 shows a prior art process for preserving input operand information of scalar integer instructions;

FIG. 3 shows a prior art prefix technology for vector instructions;

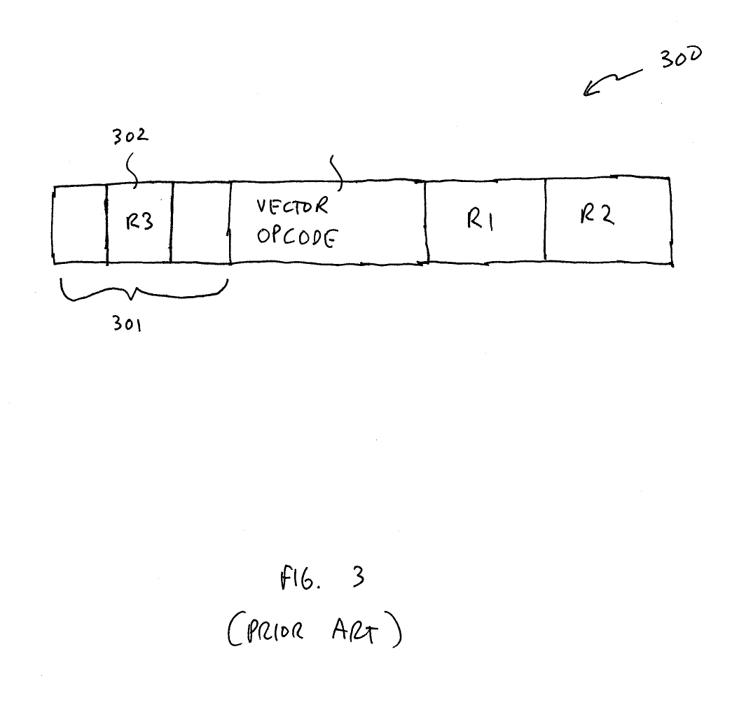

FIG. 4 shows a methodology of operation for a processing core that supports two and three register operation for both vector and scalar integer instructions;

FIG. 5 shows an embodiment of a processing core that can execute two and three register operation for its vector instruction set and its scalar integer instruction set;

FIG. 6 shows an embodiment of a scalar integer instruction format;

FIG. 7 shows a compilation process;

FIG. 8 shows an embodiment of a computing system.

### DETAILED DESCRIPTION OF THE INVENTION

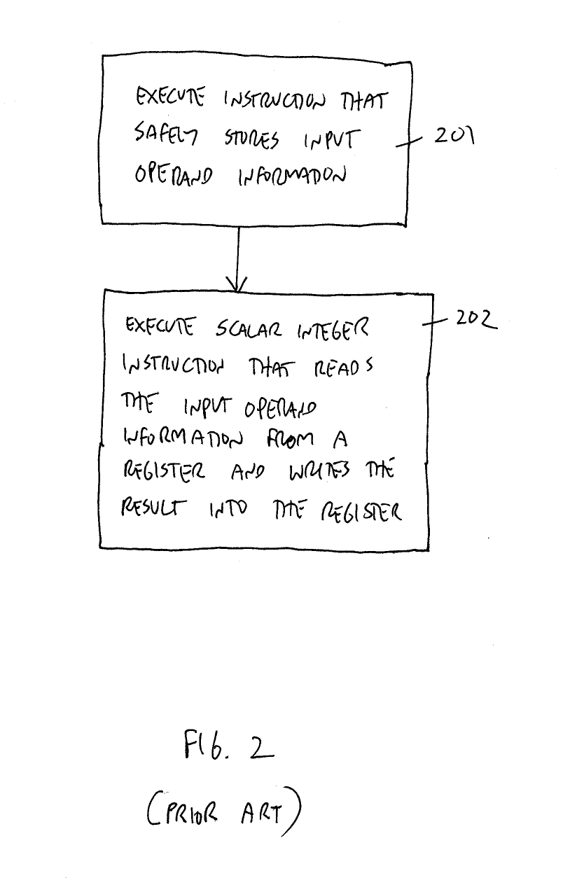

A useful improvement is to modify scalar integer instruction formats to support three register capability. Here, as described in the Background, many traditional scalar integer instructions are designed to only use two registers resulting in the destruction of one of the input operands. As such, without a preceding copy operation as described with respect to FIG. 2 of the Background, execution of these scalar integer instructions always results in destroyed input operand information.

To avoid inefficiencies associated with the destruction of input operation, the instruction format of scalar integer instructions may be modified to include prefix information (or, more generally, “additional information”) which includes the identity of a third register. As such, in cases where additional information that identifies a third register is utilized for an scalar integer instruction, the destruction of input operand information for the scalar integer instruction can be avoided. Additionally, two register operation with input operand destruction may also be effected for the same scalar integer instruction if such additional information does not exist or is otherwise not utilized.

Additionally, three register capability applied to scalar integer instructions permits a new class of “three input” scalar integer instructions to be implemented (e.g., A*B+C). That is, scalar integer instructions of the form R1<=[scalar integer opcode] R3, R2, R1 can be implemented that accept three input operands but include input operand destruction. Some scalar integer instructions may be implemented as “three register” only instructions (that is, they can not be executed with only two registers), while, other scalar integer instructions may support both “two register” and “three register” operation.

Moreover, “three register” capability may be designed into the instruction set of not only the scalar integer instruction set but also the vector instruction set of a single processing core. In this case, the processing core as it executes instructions should be designed to: 1) recognize that an scalar integer instruction is to be executed as a “two register” instruction and store the result of the instruction in one of the input operand registers such that input operand information is destroyed; 2) recognize that an scalar integer instruction is to be executed as a “three register” instruction and store the result of the instruction in a third register such that input operand information is not destroyed (in the case of a two input operand instruction), or, execute the instruction as a three input operand instruction that destroys one of the three input operands; 3) recognize that a vector instruction is to be executed as a “two register” instruction and store the result of the instruction in one of the input operand registers such that input operand information is destroyed; and, 4) recognize that a vector instruction is to be executed as a “three register” instruction and store the result of the instruction in a third register such that input operand information is not destroyed (in the case of a two input operand instruction), or, execute the instruction as a three input operand instruction that destroys one of the three input operands.

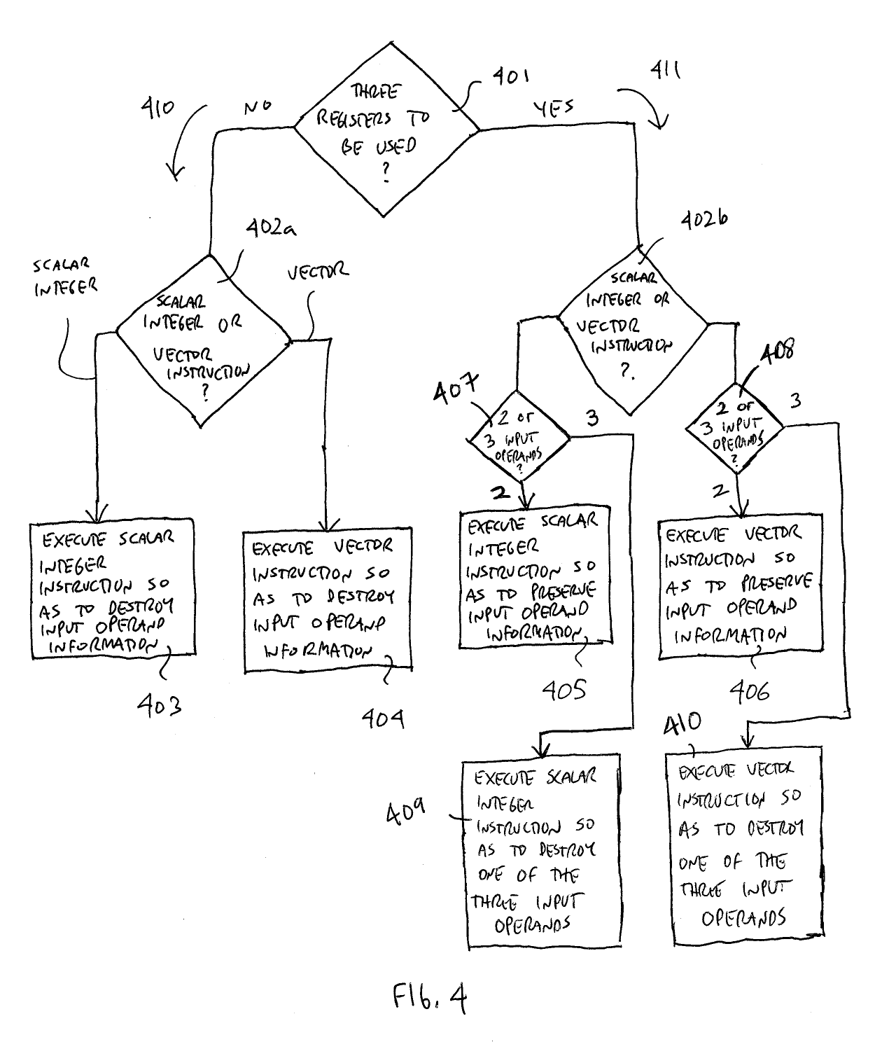

FIG. 4 shows a method of operation for a processing core that supports “extra register” instruction formatting for both scalar integer and vector instructions as described just above. According to the methodology of FIG. 4, an instruction field that signifies that the instruction is to use three separate registers is recognized or is not recognized 401. If the instruction field is not recognized (path 410), the instruction is identified as a scalar integer instruction or a vector instruction 402a. If the instruction field is not recognized (path 410) and the instruction is recognized as a scalar integer instruction, the processing core executes the instruction by reading input operand information from a pair of general purpose (scalar integer) registers in a general purpose (scalar integer) register bank and storing the result in one of the pair of scalar integer registers such that input operand information in the register that the result was written to is destroyed 403. If the instruction field is not recognized (path 410) and the instruction is recognized as a vector instruction, the processing core executes the vector instruction by reading input operand information from a pair of vector registers in a vector register bank and storing the result in one of the pair of vector registers such that input operand information in the register that the result was written to is destroyed 404.

Contrawise, if the instruction field is recognized (path 411) and the instruction is recognized as an scalar integer instruction 402b, the processing core determines whether the instruction is a two input operand instruction or a three input operand instruction 407. If the instruction is a two input operand instruction, the processing core executes the instruction by reading input operand information from a pair of general purpose (scalar integer) registers in the general purpose (scalar integer) register bank and storing the result in a third scalar integer register in the general purpose (scalar integer) register bank other than the pair of scalar integer registers such that the input operand information in the pair of scalar integer registers is not destroyed 405. If the instruction is a three input operand instruction, the processing core executes the instruction by reading input operand information from three of the general purpose (scalar registers) and storing the result in one of these three general purpose registers 409.

If the instruction field is recognized (path 411) and the instruction is recognized as a vector instruction, the processing core determines whether the instruction is a two input operand instruction or a three input operand instruction 408. If the instruction is a two input operand instruction, the processing core executes the instruction by reading input operand information from a pair of vector registers in the vector register bank 403 and storing the result in a third vector register in the vector register bank other than the pair of vector registers such that the input operand information in the pair of vector registers is not destroyed 406. If the instruction is a three input operand instruction, the processing core executes the instruction by reading input operand information from three vector registers and storing the result in one of these three vector registers 410.

Although the above method flow shows the recognition of scalar integer vs. vector instruction taking place after recognition or non recognition of an instruction field that signifies a third register is to be used, it will be apparent to those of ordinary skill that this particular ordering is not strictly required. In alternate embodiments, for example, the correct style of execution 403-406 could be identified as a direct look up from a look up table circuit, or, whether scalar integer or vector operation applies could be determined prior to the recognition or non recognition of the field that specifies a third register to be used.

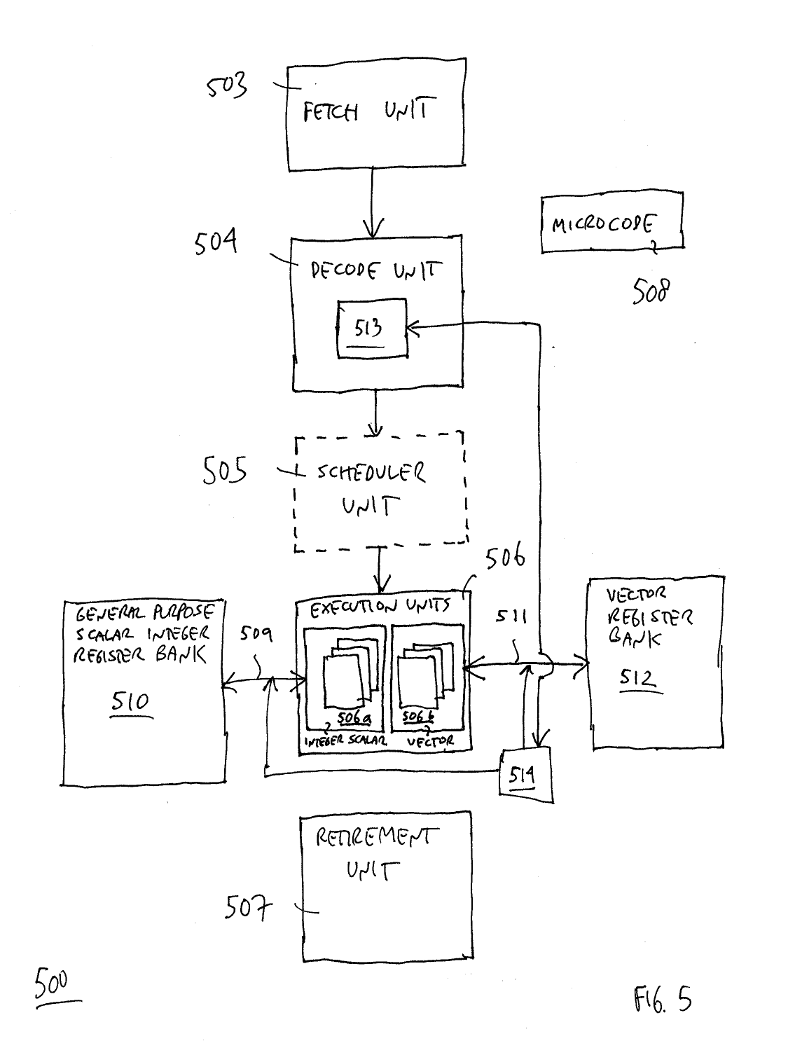

FIG. 5 shows a generic processing core 500 that is believed to describe many different types of processing core architectures such as Complex Instruction Set (CISC), Reduced Instruction Set (RISC) and Very Long Instruction Word (VLIW). The generic processing core 500 of FIG. 2 includes: 1) a fetch unit 503 that fetches instructions (e.g, from cache or memory); 2) a decode unit 504 that decodes instructions; 3) a schedule unit 505 that determines the timing and/or order of instruction issuance to the execution units 506 (notably the scheduler is optional); 4) execution units 506 that execute the instructions; 5) a retirement unit 507 that signifies successful completion of an instruction. Notably, the processing core may or may not include microcode 508, partially or wholly, to control the micro operations of the execution units 506.

The execution units 506 of the processing core 500 include scalar integer execution units 506a and vector execution units 506b. The processing core 500 includes data paths 509 between the scalar integer execution units 506a and a general purpose (scalar integer) register bank 510, and, data paths 511 between the vector execution units 506b and a vector register bank 512. Notably, the processing core 500 of FIG. 5 additionally shows logic circuitry 513 in the decode unit 504 that is designed to recognize the existence (or lack thereof) of instruction field information that identifies a third register for both scalar integer and vector instructions. Consistent with the principles outlined in FIG. 4 above, a particular scalar integer instruction may be executed as “two register with input operand destruction”, “three register without input operand destruction (two input operand)” or “three register with input operand destruction (three input operand)” depending on whether the logic circuitry 513 identifies, in the format of the scalar integer instruction, the identity of a third register to be utilized and whether the instruction accepts two input operands or three input operands. Moreover, a particular vector instruction may be executed as “two register with input operand destruction”, “three register without input operand destruction” or “three register with input operand destruction (three input operand)” depending on whether the logic circuitry 513 identifies, in the format of the vector instruction, the identity of a third register to be utilized and whether the instruction accepts two input operands or three input operands.

Datapaths 509 and 511 are setup accordingly. That is, for scalar integer instructions, datapaths 509 are established to read two or three input operands from scalar integer registers within scalar integer register bank 510 (depending on whether two or three input operand operation is detected). If logic circuitry 513 detected “two register with destruction” operation, datapaths 509 read two operands from two scalar integer registers in scalar integer register bank 510 and further direct the result of the scalar integer instruction to one of the pair of scalar integer registers. Contrawise, if logic circuitry 513 detected “three register without destruction” operation, datapaths 509 again read a pair of operands from a pair of registers in bank 510 and instead direct the result of the scalar integer instruction to a third register within the scalar integer instruction bank 510. Here, the third register is identified in the scalar integer instruction (e.g., by logic circuitry 513). Lastly, if logic circuitry 513 detected “three register with destruction” operation, datapaths 509 read three operands from three registers in bank 510 and direct the result of the scalar integer instruction to one of these registers. Again, the third register is identified in the scalar integer instruction (e.g., by logic circuitry 513).

Similarly, for vector instructions, datapaths 511 are established to read two or three input operands from a two or three vector registers within vector register bank 512 (depending on whether two input operand or three input operand operation is detected by logic circuitry 513). If logic circuitry 513 detected “two register with destruction” operation, datapaths 511 read two input vectors from a pair of vector registers in vector register bank 512 and direct the result of the vector instruction to one of the two vector registers. Contrawise, if logic circuitry 513 detected “three register without destruction” operation, datapaths 511 again read two input vectors from register bank 512 but instead direct the result of the vector instruction to a third register within the vector instruction bank 512. Here, the third register is identified in the vector instruction (e.g., by logic circuitry 513). Lastly, if logic circuitry 513 detected “three register with destruction” operation, datapaths 511 read three operands from three registers in bank 512 and direct the result of the scalar integer instruction to one of these registers. Again, the third register is identified in the vector instruction (e.g., by logic circuitry 513)

To establish the datapaths 509 and 511 as described above, steering control circuitry 514, which may include logic circuitry (such as state machine logic circuitry) and/or micro-operation logic circuitry (that processes stored micro-ops), may be designed to control the enable inputs and/or channel select inputs of various forms of steering circuits (such as line drivers, multiplexers and demultiplexers) in view of the decoding of the “two register” or “three register” information of the instruction (e.g., as performed by logic circuitry 513). The steering control circuitry may be centralized or distributed through the various stages of the processing core (such as one or more of stages 504, 505, 506, 507).

Notably, although the above description has been discussed in terms of fetching all input operands from registers banks, in a further implementation, one of the operand addresses of the instruction may be a memory address and not a register address. In this case, operation occurs as described above except that one of the operands is fetched from memory rather than a register bank. Typically the result is stored in a register bank rather than memory but various architectures may be designed differently.

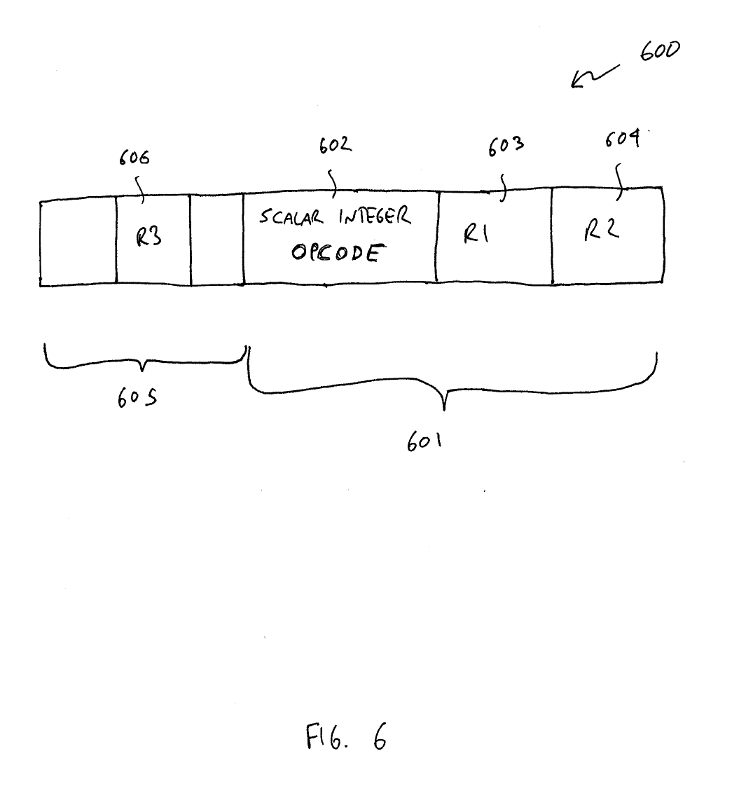

FIG. 6 shows an embodiment of scalar integer instruction format 600. The scalar integer instruction 600 includes a traditional portion 601 that includes a scalar integer opcode 602, an identifier of a first scalar integer register (R1) 603 and an identifier of a second scalar integer register (R2) 604. Alternatively, portion 604 may specify a memory address where the operand can be found. The instruction format 600 also includes a prefix portion 605 that includes an identifier of a third scalar integer register 606 that is used to prevent destruction of the input operand information in the registers that supply the input operand information for the instruction.

In an embodiment, when the three register format is utilized, the instruction 600 is understood by the machine to be of the form: [[src1] [opcode] [dest; src2]]. That is, the third register (R3) 606 that is specified in the prefix 605 is used to provide a first input operand (src1), the first register (R1) 603 that is specified in the traditional portion 601 of the instruction 600 is used to receive the result of the operation (dest) and the second register (or memory address) 604 that is specified in the traditional portion 601 of the instruction is used to receive the second input operand for the instruction. When the three register format is not utilized, the instruction is understood to follow the traditional format of [opcode] [src1/dest; src2]. Here, the first register 603 that is specified in the traditional portion 601 of the instruction 600 is used to store both a first input operand (src1) for the operation and the result of the operation (dest). The second register (or memory address) 604 that is specified in the traditional portion 601 of the instruction 600 is used to store the second input (src2).

In various processing core embodiments the scalar integer instructions that are to have “three register” operability available include one or more of the following instructions listed below in Table 1 (for simplicity each of the following instructions correspond to two input without destruction instructions).

TABLE 1

| Instruction | Description |
|---|---|
| Logical AND NOT | Performs a bitwise logical AND of the |
| | logical inverse of the first input |
| | operand and a second input operand |
| | and stores the result as a |
| | third/destination operand |
| Bit Field Extract | Extracts contiguos bits from a first |
| | input operand based on an index |
| | value and length specified in a |
| | second input operand and stores the |
| | result as a third/destination operand |
| Zero High Bits Starting with | Copies bits of a first input operand |
| Specified Bit Position | based on an index value in a second |
| | input operand and stores the copied |
| | bits in a third/destination operand |
| Parallel Bits Deposit | Lower ordered bits in a first input |
| | operand are “scattered” based on a |
| | mask in a second input operand into |
| | a third/destination operand |
| Parallel Bits Extract | Contiguous or non contiguous bits in |
| | a first operand are transferred, based |
| | on a mask in a second input operand, |
| | into contiguous bits of a |
| | third/destination operand |
| Shift | A first input operand is shifted an |
| | amount stated in a second input |
| | operand and the result is stored in a |
| | third/destination operand |

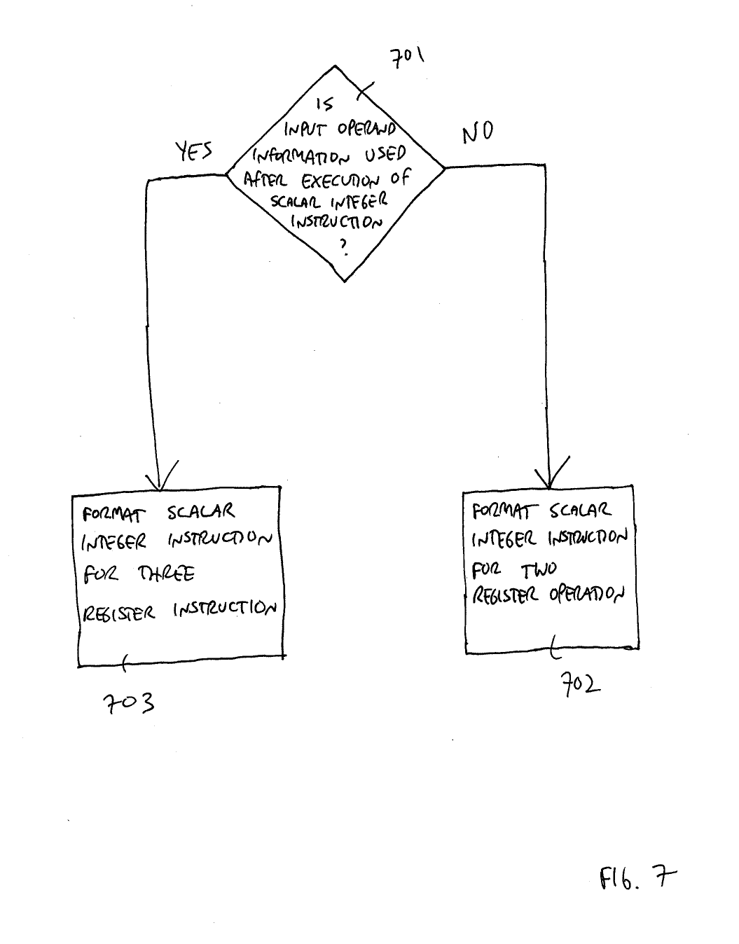

FIG. 7 shows a compilation process that can be used to produce object code that utilizes “two register” and “three register” operation as described above. According to the methodology of FIG. 7, a determination is made as to whether or not an input operand of a scalar integer instruction is utilized after execution of the scalar integer instruction 701. If an input operand of the scalar integer instruction is not utilized downstream after execution of the scalar integer instruction, then, the scalar integer instruction is formatted for two register operation 702. If an input operand of the scalar integer instruction is utilized downstream after execution of the scalar integer instruction, then, the scalar integer instruction is formatted for three register operation 703.

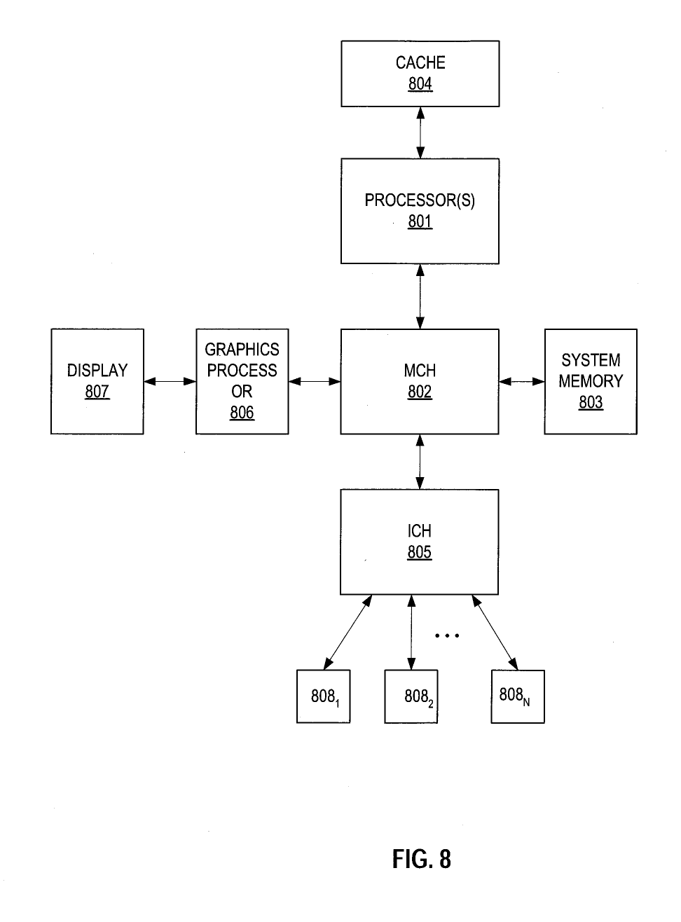

A processing core having the functionality described above can be implemented into various computing systems as well. FIG. 8 shows an embodiment of a computing system (e.g., a computer). The exemplary computing system of FIG. 8 includes: 1) one or more processing cores 801 that may be designed to include two and three register scalar integer and vector instruction execution; 2) a memory control hub (MCH) 802; 3) a system memory 803 (of which different types exist such as DDR RAM, EDO RAM, etc,); 4) a cache 804; 5) an I/O control hub (ICH) 805; 6) a graphics processor 806; 7) a display/screen 807 (of which different types exist such as Cathode Ray Tube (CRT), flat panel, Thin Film Transistor (TFT), Liquid Crystal Display (LCD), DPL, etc.) one or more I/O devices 808.

The one or more processing cores 801 execute instructions in order to perform whatever software routines the computing system implements. The instructions frequently involve some sort of operation performed upon data. Both data and instructions are stored in system memory 803 and cache 804. Cache 804 is typically designed to have shorter latency times than system memory 803. For example, cache 804 might be integrated onto the same silicon chip(s) as the processor(s) and/or constructed with faster SRAM cells whilst system memory 803 might be constructed with slower DRAM cells. By tending to store more frequently used instructions and data in the cache 804 as opposed to the system memory 803, the overall performance efficiency of the computing system improves.

System memory 803 is deliberately made available to other components within the computing system. For example, the data received from various interfaces to the computing system (e.g., keyboard and mouse, printer port, LAN port, modem port, etc.) or retrieved from an internal storage element of the computing system (e.g., hard disk drive) are often temporarily queued into system memory 803 prior to their being operated upon by the one or more processor(s) 801 in the implementation of a software program. Similarly, data that a software program determines should be sent from the computing system to an outside entity through one of the computing system interfaces, or stored into an internal storage element, is often temporarily queued in system memory 803 prior to its being transmitted or stored.

The ICH 805 is responsible for ensuring that such data is properly passed between the system memory 803 and its appropriate corresponding computing system interface (and internal storage device if the computing system is so designed). The MCH 802 is responsible for managing the various contending requests for system memory 803 access amongst the processor(s) 801, interfaces and internal storage elements that may proximately arise in time with respect to one another.

One or more I/O devices 808 are also implemented in a typical computing system. I/O devices generally are responsible for transferring data to and/or from the computing system (e.g., a networking adapter); or, for large scale non-volatile storage within the computing system (e.g., hard disk drive). ICH 805 has bi-directional point-to-point links between itself and the observed I/O devices 808.

Processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.)), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

It is believed that processes taught by the discussion above may also be described in source level program code in various object-orientated or non-object-orientated computer programming languages (e.g., Java, C#, VB, Python, C, C++, J#, APL, Cobol, Fortran, Pascal, Perl, etc.) supported by various software development frameworks (e.g., Microsoft Corporation's .NET, Mono, Java, Oracle Corporation's Fusion, etc.). The source level program code may be converted into an intermediate form of program code (such as Java byte code, Microsoft Intermediate Language, etc.) that is understandable to an abstract execution environment (e.g., a Java Virtual Machine, a Common Language Runtime, a high-level language virtual machine, an interpreter, etc.) or may be compiled directly into object code.

According to various approaches the abstract execution environment may convert the intermediate form program code into processor specific code by, 1) compiling the intermediate form program code (e.g., at run-time (e.g., a JIT compiler)), 2) interpreting the intermediate form program code, or 3) a combination of compiling the intermediate form program code at run-time and interpreting the intermediate form program code. Abstract execution environments may run on various operating systems (such as UNIX, LINUX, Microsoft operating systems including the Windows family, Apple Computers operating systems including MacOS X, Sun/Solaris, OS/2, Novell, etc.).

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A processing core implemented on a semiconductor chip, said processing core comprising:
a) logic circuitry to identify whether vector instructions and integer scalar instructions are to be executed with two registers or three registers;
b) steering circuitry coupled to said logic circuitry, said steering circuitry to control:
i) first data paths between scalar integer execution units and a scalar integer register bank such that two registers are accessed from said scalar register bank if two register execution is identified for said scalar integer instructions or three registers are accessed from said scalar integer register bank if three register execution is identified for said scalar integer instructions;
ii) second data paths between vector execution units and a vector register bank such that two registers are accessed from said vector register bank if two register execution is identified for said vector instructions or three registers are accessed from said vector register bank if three register execution is identified for said vector instructions.

2. The processing core of claim 1 wherein said integer scalar instructions include any of:
logical AND NOT;
bit field extract;
zero high bits starting with specified bit position;
parallel bits deposit;
parallel bits extract;
shift

3. The processing core of claim 1 wherein said processing core is one of a plurality of processing cores implemented on said semiconductor chip.

4. The processing core of claim 1 where, in the case of three register execution, a third register is identified in prefix information of its respective instruction.

5. The processing core of claim 1 where said logic circuitry is located within a decode stage of said processing core.

6. The processing core of claim 5 wherein said processing core is a CISC processing core.

7. A method, comprising:
analyzing a vector instruction to determine if said vector instruction is to be executed with two registers or three registers;
if said vector instruction is to be executed with two registers, accessing two registers in a vector register bank as part of said vector instruction's execution;
if said vector instruction is to be executed with three registers, accessing three registers in said vector register bank as part of said vector instruction's execution;
analyzing a scalar integer instruction to determine if said scalar integer instruction is to be executed with two registers or three registers;
if said scalar integer instruction is to be executed with two registers, accessing two registers in a scalar integer register bank as part of said scalar integer instruction's execution; and,
if said scalar integer instruction is to be executed with three registers, accessing three registers in said scalar integer register bank as part of said scalar integer instruction's execution.

8. The method of claim 7 wherein said scalar integer instruction is any of the following scalar integer instructions:
logical AND NOT;
bit field extract;
zero high bits starting with specified bit position;
parallel bits deposit;
parallel bits extract;
shift

9. The method of claim 7 wherein said analyzing of said vector instruction further includes analyzing prefix information of said vector instruction, and, said analyzing of said scalar integer instruction further includes analyzing prefix information of said scalar integer instruction.

10. The method of claim 9 wherein said analyzing of said vector instruction and said analyzing of said scalar integer instruction are performed in a decode logic stage of said processing core.

11. The method of claim 7 wherein an object code representation of said method is constructed with the following process:
determining if input operand information of said scalar integer instruction is utilized after execution of said scalar integer instruction;
if input operand information of said scalar integer instruction is not utilized after execution of said scalar integer instruction, formatting said scalar integer instruction to specify execution of said scalar integer instruction with two registers;
if input operand information of said scalar integer instruction is utilized after execution of said scalar integer instruction, formatting said scalar integer instruction to specify execution of said scalar integer instruction with three registers.

12. The method of claim 7 wherein said method is performed on a processing core of a semiconductor chip having multiple processing cores.

13. The method of claim 12 wherein said processing core is a CISC processing core.

14. The method of claim 7 further comprising effecting:
first data paths between said vector register bank and a vector execution unit in response to said determination of whether said vector instruction is to be executed with two registers or three registers;
second data paths between said scalar integer register bank and a scalar integer execution unit in response to said determination of whether said scalar integer instruction is to be executed with two registers or three registers.

15. A computing system having:
a flat panel display;
a hard disk drive; and,
a processing core having
a) logic circuitry to identify whether vector instructions and integer scalar instructions are to be executed with two registers or three registers;
b) steering circuitry coupled to said logic circuitry, said steering circuitry to control:
i) first data paths between scalar integer execution units and a scalar integer register bank such that two registers are accessed from said scalar register bank if two register execution is identified for said scalar integer instructions or three registers are accessed from said scalar integer register bank if three register execution is identified for said scalar integer instructions;
ii) second data paths between vector execution units and a vector register bank such that two registers are accessed from said vector register bank if two register execution is identified for said vector instructions or three registers are accessed from said vector register bank if three register execution is identified for said vector instructions.

16. The processing core of claim 15 wherein said integer scalar instructions include any of:
logical AND NOT;
bit field extract;
zero high bits starting with specified bit position;
parallel bits deposit;
parallel bits extract;
shift.

17. The processing core of claim 15 wherein said processing core is one of a plurality of processing cores implemented on said semiconductor chip.

18. The processing core of claim 15 where, in the case of three register execution, a third register is identified in prefix information of its respective instruction.

19. The processing core of claim 15 where said logic circuitry is located within a decode stage of said processing core.

20. The processing core of claim 19 wherein said processing core is a CISC processing core.
